(19) United States
(12) Patent Application Publication
(10) Pub. No.: US 2023/0348024 A1
(43) Pub. Date: Nov. 2, 2023

(54) Method and a System for Handling Components During Transferring of the Components from a Vessel to a Fixed Structure

(71) Applicant: ENABL A/S, Hedensted (DK)

(72) Inventor: Thomas Hedegaard, Hammel (DK)

(73) Assignee: ENABL A/S, Hammel (DK)

(21) Appl. No.: 18/006,090

(22) PCT Filed: Jul. 20, 2021
(86) PCT No.: PCT/DK2021/050243

§ 371 Date: Jan. 19, 2023

(30) Foreign Application Priority Data
Jul. 20, 2020 (DK) PA 2020 70498

(51) Int. Cl. B63B 27/10; B63B 27/30

(52) U.S. Cl. CPC B63B 27/10; B63B 27/30

(57) ABSTRACT

There is described a system for transferring components from a vessel to a fixed structure comprising a crane. The system comprises: A—providing a heave compensator between the bearing wire and the component, B-I providing at least one active clamp being arranged with connection means for connection between the vessel and the component, wherein said active clamp is arranged for being controlled by a controller being able to release the clamp and thereby free the component from its connection to the vessel, or B-II providing an accumulator is arranged for being controlled by a controller in order to release compressed air from the accumulator into the piston-cylinder unit and thereby free the component from its position on the vessel by initiating a lift of the component. The lifting of the component is effects when the vessel is near a wave crest based on a monitoring of the wave movement.

### FIELD OF THE INVENTION

The present invention relates to a method and a system for handling components, preferably wind turbine components, during transferring of the components from a vessel, preferably a floating barge, being situated on a sea surface and influenced by wave movements to a fixed structure, wherein the fixed structure preferably is a jack-up ship or the like structure fixed to a seabed or is a second vessel, preferably a floating installation vessel, wherein a crane comprising a bearing wire is provided at the fixed structure and which crane is arranged for effecting the transferring of the components.

### BACKGROUND OF THE INVENTION

An increased need of quick and safe transfer of component for offshore wind turbines from a transport barge to jack-up ship is experienced. Especially there is a need to optimize the use of costly installation vessels like jack-up ships.

When transferring component from one vessel to another vessel or to a fixed structure it is known to use heave compensation.

In the off shore industry heave compensation is known. Both passive heave compensation (PHC) and active heave compensation (AHC) are known.

Passive heave compensation is a technique used to reduce the influence of waves upon lifting and drilling operations. A simple passive heave compensator (PHC) is a soft spring which utilizes spring isolation to reduce transmissibility to less than 1. PHC differs from Active heave compensation (AHC) by not consuming external power.

The main principle in PUC is to store the energy from the external forces (waves) influencing the system and dissipate them or reapply them later. Shock absorbers or drill string compensators are simple forms of PHC, so simple that they are normally named heave compensators, while “passive” is used about more sophisticated hydraulic or mechanical systems.

A typical PHC device consists of a hydraulic cylinder and a gas accumulator. When the piston rod extends it will reduce the total gas volume and hence compress the gas that in turn increases the pressure acting upon the piston. The compensation ration is low to ensure low stiffness. A well designed PHC device can achieve efficiencies above 80 percent.

Active heave compensation (AHC) is a technique used on lifting equipment to reduce the influence of waves upon offshore operations. AHC differs from PHC by having a control system that actively tries to compensate for any movement at a specific point, using power to gain accuracy.

The purpose of AHC is to keep a load, held by equipment on a moving vessel, motionless with regard to the seabed or another vessel. Commercial offshore cranes usually use a motion reference unit (MRU) or pre-set measurement position detection to detect the current ship displacements and rotations in all directions. A control system, often PLC or computer based, then calculates how the active parts of the system are to react to the movement. The performance of an AHC system is normally limited by power, motor speed and torque, by measurement accuracy and delay, or by computing algorithms. Choice of control method, like using preset values or delayed signals, may affect performance and give large residual motions, especially with unusual waves.

State of the art AHC systems are real time systems that can calculate and compensate any displacement in a matter of milliseconds. Accuracy then depends on the forces on the system, and thus the shape of the waves more than the size of the waves.

Examples on passive heave compensator are found in the following link:
https://www.youtube.com/watch?v=CaeLNxQPFHI
https://www.youtube.com/watch?v=4Yh6_L2ZkxA
https://www.youtube.com/watch?v=icXjNxpO7_4
https://www.youtube.com/watch?v=Hw97zBYEPlw

Examples on active heave compensator are found in the following link:
https://www.youtube.com/watch?v=Hw97zBYEPlw
https://www.youtube.com/watch?v=eYGqREJ4ZAQ
https://www.youtube.com/watch?v=jOvZeWkDZDs

When comparing the AHC and PHC it occurs that AHP requires adding energy/movements. Accordingly there is a requirement for large power supply and HPU which makes the AHP mere complex and more costly than PHC. In the off shore industry emergency disconnection systems (EDS) are known. EDS may be a part of an emergency disconnect package (EDP) which may comprise a blow out preventing system (BOP).

An EDP is a piece of equipment used in the drilling and work-over (servicing or modification) of deep sea oil & gas wells, by mobile offshore drilling rigs (MODU's) and well intervention vessels (WIV's). The EDP is designed for use in an emergency, when the MODU or WIV needs to quickly disconnect, and move away from the oil/gas well that it is drilling or working-over. Examples of when this might be necessary include unexpected extreme weather that exceeds the MODU/Vessel's capability to maintain its position.

Under normal operating conditions, the MODU/WIV (which is floating on the sea surface) is connected to the oil/gas well (which is drilled in the sea bed) by a vertical (or near-vertical) piece of steel pipe, called a marine riser. Tools and fluids are moved within the marine riser as required to/from the well. At the bottom of the marine riser, the EDP and other components that connect the riser to the well and allow the well to be shut-in when required, constitute a ‘lower riser package’ (LRP).

When required to do so, the EDP disconnects from the LRP and isolates the riser from the environment. Thus the EDP allows the MODU/WIV to safely and quickly disconnect from the subsea well and move away in an emergency. The EDP is designed to carry out its function while under load with a high disconnection angle.

An EDP comprises a connector or EDS which connects to the rest of the LRP, an isolation valve, an accumulator, a subsea control module and a connection point at the top for connection to the riser pipe. A production retainer valve shuts in the riser and the annulus master valve shuts in the riser. A crossover valve allows circulation of the riser after disconnection.

The EDS may be disconnected in a controlled manner. This may be effected either as result of a control signal from a control unit or as a result that a pre-determined force is exerted on a coupling in the EDS.

Examples on emergency disconnection systems are found in the following link:
https://www.youtube.com/watch?v=j5e8QID_q4s
https://www.youtube.com/watch?v=HaTGeGhWVYs
https://www.youtube.com/watch?v=FzukEnCNFRg

In prior art there is no teaching of combining these technologies in a method or a system for transferring of components from a vessel, preferably a floating barge, being situated on a sea surface and influenced by wave movements to a fixed structure, preferably a jack-up ship or the like structure fixed to a seabed or to a second vessel, preferably a floating installation vessel.

WO 2018/106105 A1 disclose a system for transferring components from a floating structure, such as a vessel, to a fixed wind turbine installation at sea. A motion compensation device is disclosed in the form of level setting device and a slewing jib beam support member and a jib beam drive which is controlled by a controller. This document does not disclose an active clamp between the vessel and the component and neither disclose an accumulator for freeing the component from its position on the vessel and initiating a lift of the component.

### OBJECT OF THE INVENTION

It is the purpose of the present invention to provide a method and a system for quick and safe transferring of components from a vessel, preferably a floating barge, being situated on a sea surface and influenced by wave movements to a fixed structure, preferably a jack-up ship or the like structure fixed to a seabed by using a crane.

Moreover it is the purpose to provide such method and such system which makes it possible that the crane used may provide an over-pull when using of a combination of well-known technologies.

### DESCRIPTION OF THE INVENTION

According to the present invention this purpose is obtained with a method mentioned in the introduction and which method comprising the step of:
A—providing a heave compensator being arranged with connection means for connection between the bearing wire and the component, wherein said heave compensator comprises at least one hydraulic piston-cylinder unit and at least one accumulator for compressed air, which accumulator is connected with the piston-cylinder unit,
B-I providing at least one active clamp being arranged with connection means for connection between the vessel and the component, wherein said active clamp is arranged for being controlled by a controller being able to release the clamp and thereby free the component from its connection to the vessel, or
B-II providing an accumulator is arranged for being controlled by a controller in order to release compressed air from the accumulator into the piston-cylinder unit and thereby free the component from its position on the vessel by initiating a lift of the component,
C—providing means for monitoring wave movements,
D—arranging the vessel on site of the fixed structure,
E—connecting the heave compensator to the bearing wire
F—connecting the active clamps to the vessel and the component to be transferred, in the situation where step B-I is used, or connecting the accumulator to the piston-cylinder unit, in the situation where step B-II is used,
G—pre-setting the heave compensator for the load of the component to be transferred, eg. the weight of the load+10%,
H—bringing the heave compensator in position for attachment to the component,
I—connecting the heave compensator to the component to be transferred and tightening the bearing wire to a pull where the heave compensator is operated in a middle area where a constant over-pull is established in the component to be transferred,
J—monitoring the wave movement and sending information of the wave movement to the controller,
K—calculating in the controller the wave movement to determine at least when crests are expected at the vessel,
L—releasing the active clamp, in the situation where step B-I is used, or releasing compressed air from the accumulator into the piston-cylinder unit, in the situation where step B-II is used, when the vessel is near a wave crest, which releasing is controlled by a control signal from the controller being submitted as a result of information from the monitoring of the wave movement,
M—hoisting the component from the vessel and transferring it to the fixed structure,
N—detaching the component from the heave compensator,
O—repeating the steps E to N until all necessary components are unloaded from the vessel,
P—removing the vessel from the site of the fixed structure, and
Q—arranging a new vessel on site of the fixed structure if more components are needed and repeating steps E to P.

The system according to the invention comprises:
A—a heave compensator being arranged with connection means for connection between the bearing wire and the component, wherein said heave compensator comprises at least one hydraulic piston-cylinder unit and at least one accumulator for compressed air,
B-I at least one active clamp being arranged with connection means for connection between vessel and the component, wherein said active clamp is arranged for being controlled by a controller being able to release the clamp and thereby free the component from its connection to the vessel, or
B-II an accumulator which is arranged for being controlled by a controller in order to release compressed air from the accumulator into the piston-cylinder unit and thereby free the component from its position on the vessel by initiating a lift of the component,
C—means for monitoring wave movements and
D—a control unit which is connected with the means for monitoring the wave movement, with the heave compensator and with the clamp and/or the accumulator.

In the present invention the term “fixed structure” will cover both a structure fixed to the seabed and a structure in forum of a second vessel being situated on a sea surface and influenced by wave movements. The component is to be transferred to the “fixed structure”.

In the present invention step G of the method is effected in combination with step BI with a bias of e.g. 10%. When step BII is used, then it is not possible to preset the heave compensator with a bias of e.g. 10% as step BII typically not involves use of active clamps.

In the context of the present invention it is important to control the lift off of the component from the vessel influenced by the wave movements by means of a crane situated on the fixed structure.

In the situation where the fixed structure is a second vessel the calculation shall take into account he mutual movement of the two vessels being subject to the wave movement. Here the releasing of the active clamp is effected when the mutual movement causes a lowering of the vessel in relation to the movement of the fixed structure.

In a heave compensator according to the present invention the volume of the accumulator shall be very large so that only minor pressure differences in the air is experienced during use. Hereby it is possible to operate with a substantially constant pressure on the hydraulic piston-cylinder unit. Pressure differences may be within limit occurring in commercial accessible compensator for example compensators as described above. Such compensators may be used to carry out the present.

In the context of the present invention the term “air” can mean any air or any gas suitable to be used in a heave compensator, including Nitrogen.

Jack-up ships may be used in a more efficient way when transferring components from the vessel in form of a transport barge to the jack-up ship according to the above described method according to the present invention.

It is possible to optimize the time where a jack-up ship may be situated on site where an installation shall be effected e.g. of an off-shore wind turbine.

Practical experience has illustrated that normally the utilization of wind turbines would be 57% for at jack-up ship. Calculations based on the present method have demonstrated that the utilization may be increased to at least 65%.

The method according to the present invention involves the use of the heave compensator which may be a standard type known in prior art. Heave compensator provides a relief of the crane which primarily is the peak load which the crane would be subject to if no heave compensator was used.

The crane would be subjected to a dynamic application factor (DAF) which typically could be 1,2 which means an increased load on the crane being 20%. However, this factor may be reduced to substantially 0 when using a passive heave compensator which may be a standard product in the market.

With the present invention it is possible to provide an over-pull with the crane. The timing when the component is lifted free is determined by the monitoring of the wave movements which are influencing the movement of the heave compensator. When having monitored a number of wave periods it is possible to predict a wave crest. The over-pull which may be provided could be in the size of 5-20%. The over-pull provides by the active clamps which hold the structure fixed to the vessel ensures that the component always will be lifted free from the vessel when releasing the clamp.

The correct timing of the lifting may be determined in two ways.

A first way is to use an active clamp which in principle is known from emergency disconnection systems. The release of the active clamp is controlled by a controller which receives signals from the monitoring of the wave. Accordingly, the controller may submit a control signal to the active clamp and free the component from its connection to the vessel when the vessel is at a wave crest.

When the crane is connected with the component the heave compensator maintains a substantially constant load on the main crane while monitoring and predicting of the wave movement is monitored and the movement of the waves are calculated. The load on the main crane will be influenced by the minor pressure differences and depend on the position of the piston. However the load is maintained in a middle area whre the over-pull is established. When the vessel is near a wave crest the clamps are released by the control signal and the component is gently lifted off the deck using the force of the heave compensator while the crane hoists the load.

The second way is to use an accumulator which is known from heave compensators. Alternatively to the active clamp the heave compensator may be arranged with an accumulator for compressed air connected with the piston-cylinder unit of the heave compensator. In this situation the control signal from the controller will open the connection between the accumulator and the piston-cylinder unit of the heave compensator. Hereby the component is gently lifted of the deck of the vessel using the force of the heave compensator while the crane hoists the component.

As it occurs from the above the heave compensator is used to gently lift off the component from the vessel using the force of the heave compensator while the main crane hoists the load.

Accordingly, it is possible to have over-pull in the system which ensures that the component is lifted free of the vessel when the vessel is at a wave crest without the risk of overloading the crane.

As the components to be transferred are heavy the hoisting of the crane is relatively slow. Even though the wave movement are monitored and the lifting is initiated when the component is at a wave crest there may be a risk that a new wave arrives and will raise the vessel even higher and thereby may lead to a situation where the deck of the vessel collides with the component. Here it shall be remembered that the vessel after being freed form the load of the component is lightened and may raise solely due to its own buoyancy. As the lifting off of the component is assisted by the heave compensator it is possible to reduce the risk of such collision. At the same time the crane will not be overloaded even though the initial hoisting speed is higher than allowed by the capacity of the crane.

In case the active clamp is used the accumulator for compressed air is connected with the piston-cylinder unit a closed system is established having a constant volume of air which ensures the substantially constant force. Accordingly this system may be used repeatedly for transferred a number of components.

When using a release of the compressed air from the accumulator to lift the component free of the vessel, the system is an open system and energy is supplied in form of compressed air for the lift off. There is a need to “reload” the accumulator for enabling the system to effect the following lift off.

It is possible to provide more than one accumulator as the heave compensator then may be used a number of times before the accumulators thereof shall be reloaded.

Accordingly, it is preferred to use the system with an active clamp. Such active clamp may be provided as a set of clamps which is released synchronously or one single clamp which is provided in a frame to which the component is attached. Such frame may be a transport frame for one or more component to be transferred.

The clamps comprise coupling elements which are able to the disconnected by remote control from the controller. Such coupling elements may typically be mechanical couplings which are known from clamps in prior art release systems.

According to a further aspect of the invention Step A includes providing a heave compensator which is a passive heave compensator.

It is possible to use a heave compensator which is a technically simple solution compared to an active heave compensator. Accordingly, the system will have the advantages explained above and not have the disadvantages of a complex and costly active heave compensator.

According to a further aspect of the invention wherein Step A includes providing a heave compensator comprising at least two hydraulic piston-cylinder units and at least two accumulators for compressed air.

It is also possible to use only one large accumulator together with two or more hydraulic piston-cylinder units.

When using a heave compensator comprising two or more hydraulic piston-cylinder units and two or more accumulators—or only one large accumulator—for compressed air it is possible to one single heave compensator/tool for lifting components having different weight.

The volume of the compensator may vary and have the size of the commercial accessible compensator for example compensators as described above. Such compensators may be used to carry out the present.

When lifting components for a wind turbine from a transport barge to a jack-up ship there may be need for transferring components having a weight from approximately 1,000t for a nacelle and blades which may weight approximately 40t. Seeing that a passive heave compensator is dimensioned for a specific load there will be a need to exchange the traditional heave compensator comprising only one cylinder/piston unit. In order to use one heave compensator for multiple different loads it is possible to activate or inactivate each hydraulic cylinder-piston unit e.g. by opening or closing electrical control hydraulic valves. By combining a number of hydraulic cylinders it is possible to adapt the heave compensator to the load. E.g, it is possible to combine 50t+100t 250t cylinder-piston units to achieve a lifting capacity of 400t.

Likewise it is also possible to use either of the hydraulic cylinder-piston units alone or in combination with only one or two hydraulic cylinder-piston units.

The heave compensator will comprise connection means in form of a lifting shackle, lifting slings or the like intended to be attached to a hook in the bearing wire of the crane. A piston lock mechanism will be attached to the accumulators/hydraulic cylinder-piston units whereby it is possible to combine/lock together the cylinder-piston units desired for a specific load of a component. The accumulators will preferably comprise compressed nitrogen.

In the heave compensator trunnions would normally be fixed to the lower part of the heave compensator and these trunnions will normally be used as lifting points for the component to be transferred. Trunnions may also be used if the heave compensator consists of only one hydraulic cylinder-piston unit and one accumulator for compressed air.

According to a further aspect of the invention Step A includes providing the at least two hydraulic piston-cylinder units with different lifting capacities.

As explained above it is possible to combine a selected number of hydraulic piston-cylinder units and thereby obtain a lifting capacity which is adapted to a specific load for the component to be transferred.

According to a further aspect of the invention Step A includes combining a selected number of the hydraulic piston-cylinder units by connecting these by opening/closing hydraulic valves arranged in pipe connections between the hydraulic piston-cylinder units and activating the selected number of hydraulic piston-cylinder units in order to obtain a desired lifting capacity for the load of the component to be transferred.

Alternatively the piston-cylinder units may be disconnected mechanically by using a pin which may be moved out of engagement with a piston and thereby leaving this

According to a further aspect of the invention Step B includes remote controlling the active clamp with a signal from the control unit.

It is preferred that the active clamp is controlled through remote controlling even though it is possible to have a wiring from the controller to the active clamp for transferring a release signal.

According to a further aspect of the invention Step L includes a releasing the active clamp from the component leaving the active clamp still connected to the vessel.

It is preferred that the active clamp will be connected to the vessel and that the coupling elements to be released are arranged between the clamp and component. Hereby the active clamp may be reused for several components as a new component is attached to the active clamp after one component has been transferred to the fixed structure.

Alternative it is also possible to use more active clamps.

It is important that it is possible to avoid the need of a crane on the vessel.

According to a further aspect of the invention Step I includes providing a lifting yoke customized to the specific component, arranging the component in the lifting yoke and connecting the heave compensator to the lifting yoke.

Specific lifting yokes are used for different components of a wind turbine, e.g. the blade, the nacelle, the tower sections etc. Therefore, it is beneficial if the heave compensator is connected to the lifting yoke.

In situation where the active clamp is used such active clamp may also be connected to the lifting yoke, which is also connected with the crane hook. The active clamp may at its other part be connected the deck of a transport vessel or to a transport frame arranged on the deck of the transport vessel. When activating the active clamp and releasing the connection, the lifting yoke will be freed from clamp which will still be connected to the vessel hereby it may be lifted by the crane. Alternatively the active clamp may be directly connected to the component to be transferred. When activating the clamp the component and the lifting yoke is freed and may be lifted by the crane.

According to a further aspect of the invention the heave compensator comprises at least two hydraulic piston-cylinder units and at least two accumulators for compressed air, wherein the at least two hydraulic cylinders have same or different lifting capacities and wherein the hydraulic cylinders are connected through pipe connections comprising hydraulic valves, which valves are arranged for being opened/closed thereby activating a selected number of hydraulic cylinders in order to obtain a desired lifting capacity for the load of the component to be transferred.

As explained above it is beneficial if the system has two or more hydraulic piston-cylinder units as it is possible to adapt the heave compensator to different loads. It is possible two or more hydraulic piston-cylinder units together with only one accumulator for compressed air.

### DESCRIPTION OF THE DRAWING

The invention will be described in further detail below by means of non-limiting embodiments with reference to the schematic drawing, in which:

FIG. 1 shows a schematic side view of heave compensator for use in a system according to the present invention,

FIG. 2 shows a top view of the heave compensator illustrated in FIG. 1 according to arrows A-A in FIG. 1,

FIGS. 3-14 illustrate steps of a method for transferring a component from a vessel to a fixed structure according to the present invention using an active clamp,

FIG. 15 corresponds to FIG. 12, however, illustrating the lifting of a different component,

FIG. 16 corresponds to FIG. 12, however, illustrating a lifting of a further different component,

FIGS. 17-18 illustrate steps of an alternative method for transferring a component from the vessel to the fixed structure according to the present invention using an accumulator,

FIG. 19 illustrates a sketch of a lifting scenario,

FIG. 20 illustrates a schematic view of an active clamp according to a first embodiment

FIG. 21 illustrates a schematic view of a further embodiment for an active clamp according to the present invention,

FIG. 22 illustrates a partial view of a part of an active clamp corresponding to the one illustrated in FIG. 21, and

FIG. 23 illustrates a further embodiment for an active clamp according to the present invention.

### DETAILED DESCRIPTION OF THE INVENTION

In the drawing, the same reference numerals have been used for the designations of identical or like elements.

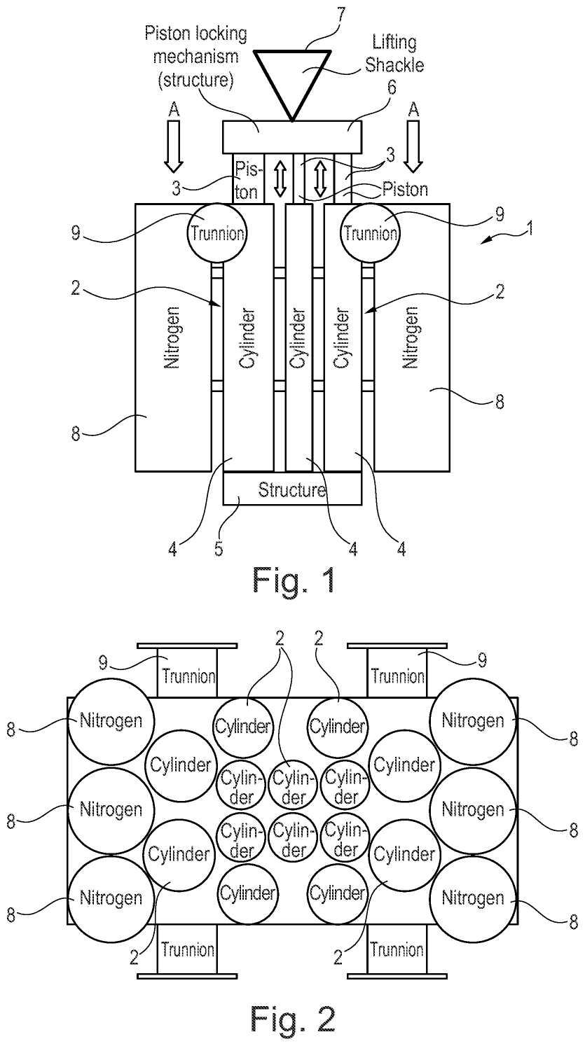

FIGS. 1 and 2 show a side view and a top view of a heave compensator 1. The heave compensator comprises a number of hydraulic piston-cylinder units 2, each comprising a cylinder 4 and a cooperating piston 3.

The cylinders are affixed to a structure 5 of the heave compensator 1.

The pistons are combined with a piston locking mechanism 6 being a part of the structure of the heave compensator.

The heave compensator is connected with a lifting shackle 7 for attaching to a hook in a bearing wire of a crane. Furthermore, the heave compensator 1 comprises accumulators 8 for compressed air.

The heave compensator 1 furthermore comprises trunnions 9 which may be used as lifting points for components to be transferred. The hydraulic piston-cylinder units 2 are illustrated with different sizes indicating that they are dimensioned for different loads.

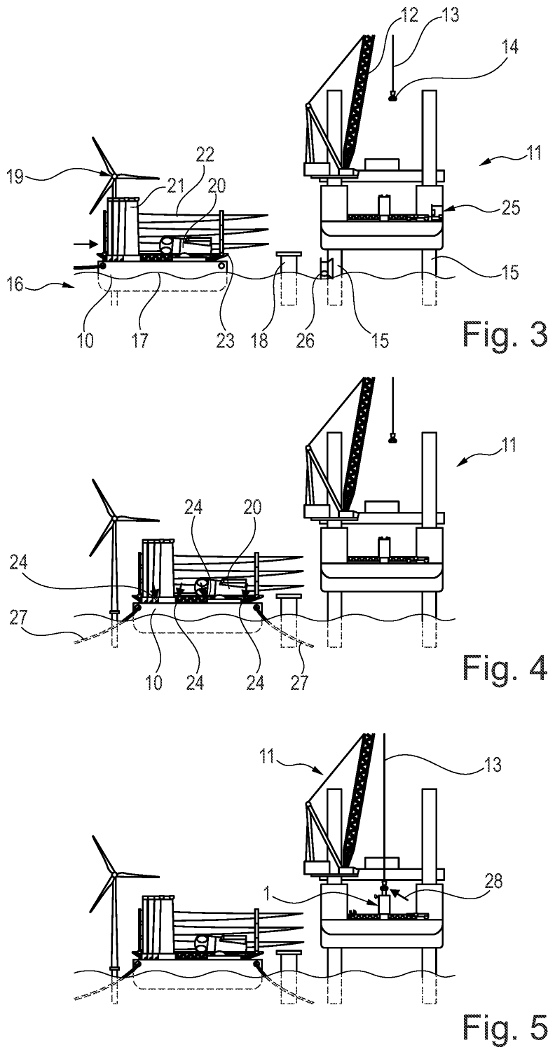

FIG. 3 illustrates that a vessel 10 in form of a transport barge arrives on site of a fixed structure 11 in form of a jack-up ship.

The jack-up ship is provided with a crane 12 having a bearing wire 13 provided a connector 14 for connection with the lifting shackle 7 of the heave compensator. The fixed structure is provided with piles 15 which are affixed to the sea-bed (not illustrated).

The vessel 10 is floating on the sea-surface 16. As illustrated the waves are at the sea-surface, and 17 illustrates a wave crest.

FIG. 3 illustrates a foundation 18 for a wind turbine 19. The vessel 10 transports a nacelle 20, tower sections 21 and blades 22 which are provided on the deck 23 of the vessel 10. Alternatively a fully assembled tower (not illustrated) may be arranged on the vessel 10.

The nacelle 20, the tower sections 21 and the blades 22 will as indicated by arrows 24 in FIG. 4 be secured to the vessel 10 during transportation.

The fastening may be effected with active clamps which are arranged for being controlled by a controller indicated at 25 (only illustrated in FIG. 3). The control of the active clamps is primarily based on remote control. The controller 25 is furthermore connected with wave monitoring means 26 (only illustrated in FIG. 3). The wave monitoring means are intended for monitoring wave movements and sending a signal to the controller 25. The controller calculates the wave movement and can determine when a wave crest 17 arrives at the vessel 10.

FIG. 3 illustrates that the heave compensator 1 is arranged on the fixed structure 11.

It is noted that the different elements which are illustrated in FIGS. 3-18 are not explained in connection with each of these figures and that these elements are not indicated with reference numerals in all figures.

FIG. 4 illustrates that the vessel 10 is maintained in the position close to the fixed structure 11 by means of anchoring lines 27 connected to anchors at the seabed (not illustrated). The anchoring lines 27 allow the vessel 10 to follow wave movements.

Other anchoring methods and anchoring means which maintain the position close to the fixed structure 11 is also possible, e.g. clamps used for clamping the vessel 10 to the fixed structure 11.

FIG. 5 illustrates with arrow 28 that the heave compensator 1 is attached to the bearing wire 13. During this step the heave compensator will be configured for the appropriate load depending on whether it is the nacelle 20 to be transferred or a tower section 21 or one or more blades 22,

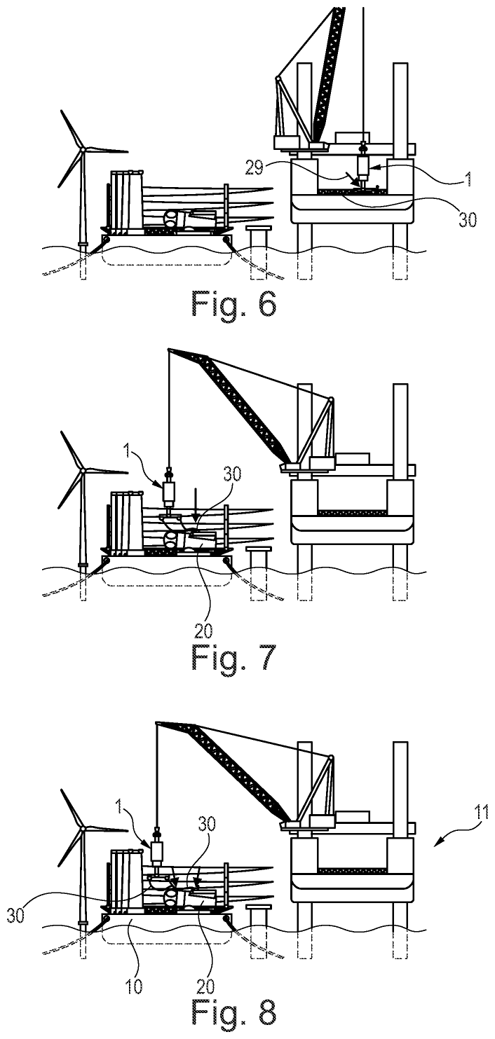

FIG. 6 illustrates that a nacelle lifting yoke 29 is attached to the heave compensator 1 and fitted with long slings 30. The length of the slings 30 will depend on the wave amplitude and alternatively quick connectors may be used.

FIG. 7 illustrates that e slings 30 are landed on top of the nacelle 20.

FIG. 8 illustrates that the slings 30 are attached to lifting equipment for the nacelle 20.

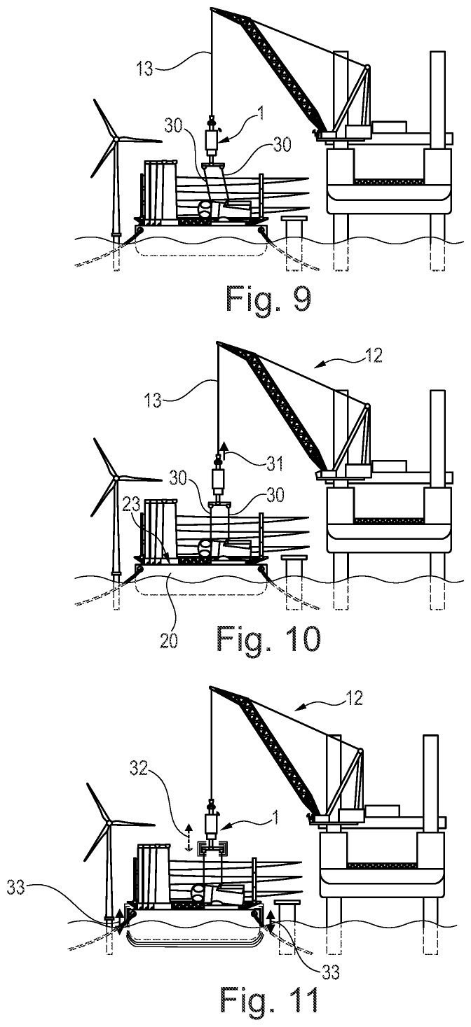

FIG. 9 illustrates an initial hoisting. In this step the heave compensator is pre-set for the load of the nacelle. Typically the pre-set of the load will be the weight of the nacelle+10%. For a nacelle weighing 500t the pre-set will be 550t.

FIG. 10 illustrates that the crane 12 tightens the slings 30. This is indicated by arrow 31. During this tightening of the slings 30, the nacelle is still clamped to the deck 23 of the vessel 10 by means of an active clamp.

FIG. 11 illustrates that the wave frequency is measured with the monitoring means 26 (see FIG. 3). When determine the wave frequency in the controller 25 (see FIG. 3) it is predicted how the movement of the wave will be and accordingly, also there is a prediction of the movement of the heave compensator 1. The movement of the heave compensator is indicated with arrow 32. Arrows 33 indicate the wave movements.

During the monitoring step, the heave compensator 1 maintains a constant load on the crane 12.

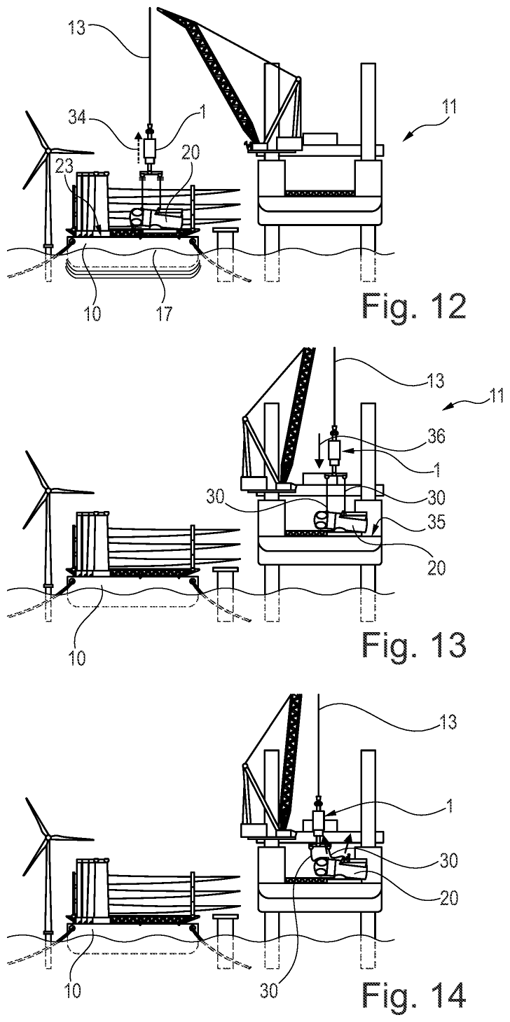

FIG. 12 illustrates the situation where the deck 23 of the vessel is at an upper position as the vessel is near the wave crest 17. At this time the deck clamps are released by remote control from the controller 25 (see FIG. 3.) and the nacelle 20 is gently lifted off the deck as indicated by arrow 34 using the force of the heave compensator 1 while the crane 12 hoists the nacelle 20 with the bearing wire 13.

The nacelle 20 is now freed from the vessel 10, and the crane can transfer the nacelle 20 to the fixed structure 11.

FIG. 13 illustrates that the crane 12 hoists the nacelle onto a deck 35 of the fixed structure 11. This lowering of the nacelle is indicated with arrow 36.

FIG. 14 illustrates that the bearing wire further lowering the heave compensator 1 whereby the slings 30 are loosened and can be detached from the nacelle 20.

The crane is now the ready to the next lift where a different lifting yoke may be used together with the heave compensator.

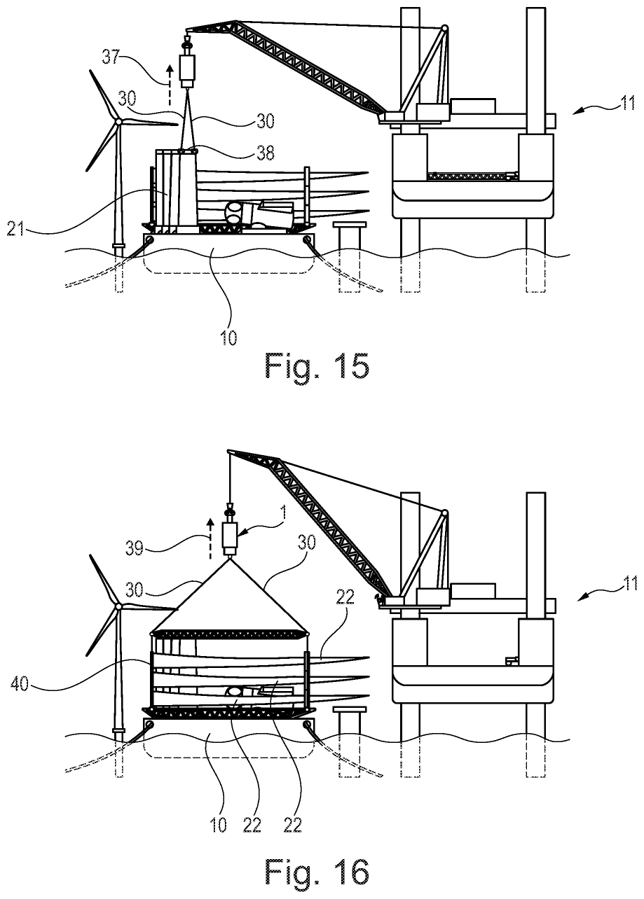

FIG. 15 illustrates a situation where further components are transferred from the vessel 10 to the fixed structure 11.

FIG. 15 illustrates with arrow 37 the lifting of a tower section 21. The tower section is connected with the slings 30 through a lifting bracket 38 connected to the tower section. The tower section is also connected with the deck 23 of the vessel 10 by means of active brackets.

The steps for transferring the tower section will be like the steps described above in relation to the transferring of the nacelle 20.

FIG. 16 illustrates the lifting of blades 22 from the vessel 10. The lifting is illustrated with arrow 39. The blades are attached to a rack 40 containing three blades with could be lifting simultaneously from the vessel 10 and transferred to the fixed structure 11. The rack 40 is connected to the vessel 10 with an active clamp.

The steps for transferring the blade rack 40 will be like the steps described above in relation to the transferring of the nacelle 20.

When the vessel 10 is emptied it can be removed from the site of the fixed structure and sail to a harbor for being loaded with new components.

A new vessel may be anchored close to the fixed structure and the procedure explained above may be repeated as many times as necessary.

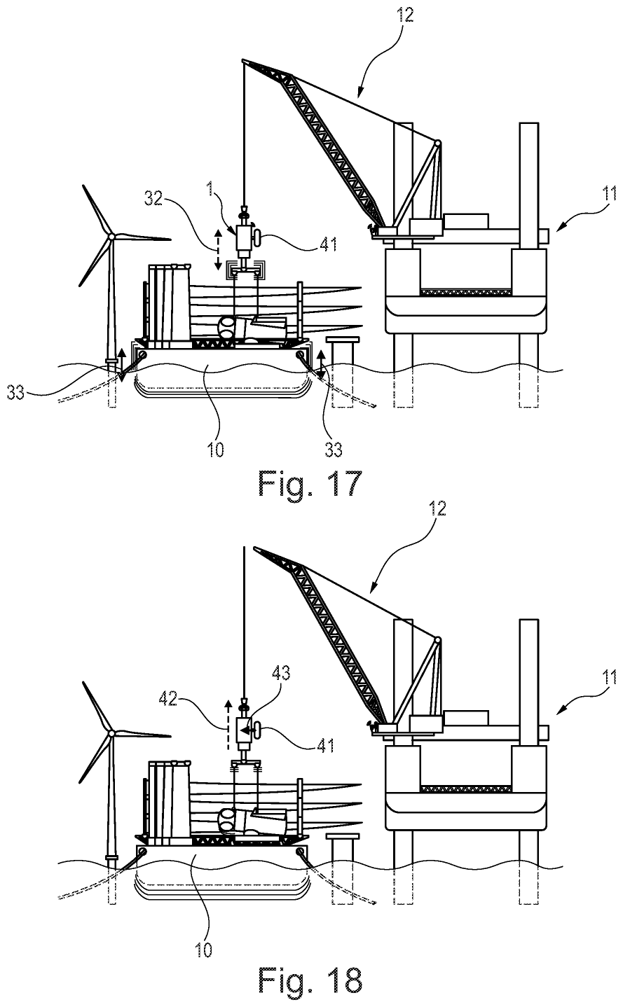

FIG. 17 illustrates a picture corresponding to FIG. 12.

However, in the embodiment in FIG. 17 and FIG. 18 active clamps for affixing the nacelle 20 to the vessel 10 are not used. In the embodiment illustrated in FIG. 17 the heave compensator 1 is provided with an accumulator 41 for compressed air. The accumulator 41 is connected with the piston-cylinder unit of the heave compensator through a valve (not illustrated) which may be controlled in the same way and according to the same principle as the control of the release of the active clamp.

Accordingly, in this embodiment the valve is opened when the vessel 10 is near a wave crest 17 and the release of the compressed air will gently lift off the nacelle from the deck due to the force of the heave compensator while the crane lift the nacelle 20. This lifting is illustrated in FIG. 18 with the arrow 42, and the arrow 43 illustrates the release of the compressed air from the accumulator 41.

The crane will lift the major part of the load, typically around 90%. Before the compressed air is released and provide more power to the piston-cylinder unit. The piston-cylinder unit is thereby retracted causing the lift off of the component from the vessel.

Accordingly, the method illustrated in FIGS. 17 and 18 differs from the above mentioned method in that active clamps are not used for attaching and freeing the component from the vessel. In this embodiment the components situated on the vessel 10 shall be loosened from the deck, by releasing passive transport brackets which has been used during transport from harbor to the site of the fixed structure.

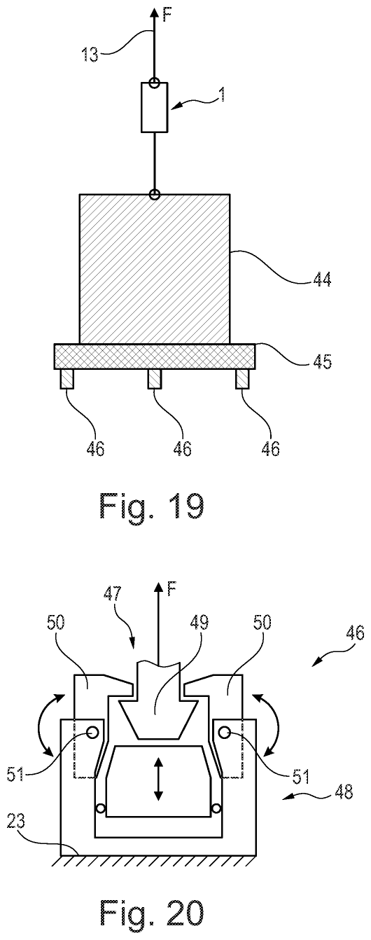

FIG. 19 illustrates a component 44 to be transferred when lifted by the bearing wire 13. 45 is an interface between the component 44 and an active clamp which is designated with 46. The active clamp 46 may be denoted as a release mechanism.

FIG. 20 illustrates the active clamp 46 in accordance with a first embodiment. The active clamp 46 comprises a first interface 47 to the component to be transferred and a second interface 48 to be connected to the deck 23 of the vessel. The first interface 47 comprises a rod having a pointed head 49. The pointed head 49 is wedged between claws 50 which are arranged to be rotated around shafts 51 in order to engage or disengage the active clamp.

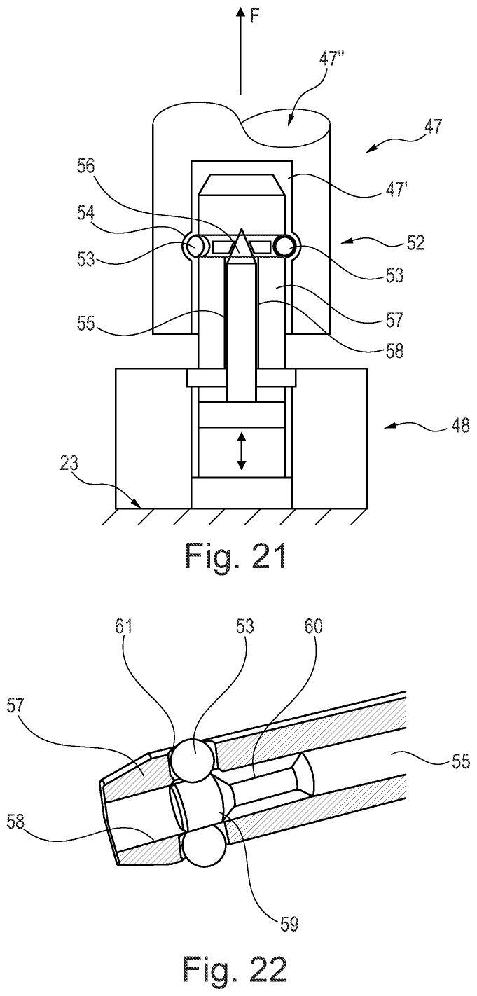

FIG. 21 illustrates a further embodiment for an active clamp. The first interface 47 comprises a bore 47′ in a rod 47″. The second interface 48 comprises a ball lock mechanism 52. The ball lock mechanism 52 comprises balls 53 provided in a groove 54 in the rod 47′. A rod 55 is arranged in a tubular sleeve 57 having an inner surface 58. The rod 55 is provided with a pointed end 56 which may force the balls 53 into the groove 54 and engage the active clamp. When retracting the rod 55 as indicated by the double arrow the balls 53 are freed and the active clamp is disengaged.

FIG. 22 illustrates the principle for a ball lock mechanism which is slightly different from the ball lock mechanism illustrated in FIG. 21. The rod 55 illustrated in FIG. 22 comprises a narrowed part 60 ending in an enlarged head 59. The rod 55 is sliding within the tubular sleeve 57. The balls 53 are provided in openings 61 to enter into the groove 54 (not illustrated in FIG. 22), when activating the active clamp in order to provide an engagement. When disengaging the active clamp, the rod 55 is pushed to the left side, whereby the balls 53 will be situated in front of the narrowed part 60. Hereby the active clamp is disengaged.

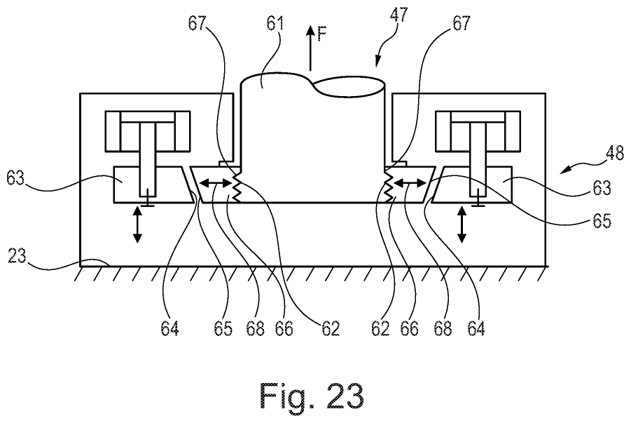

FIG. 23 illustrates that the first interface 47 comprises a rod 61 provided with a toothing 62. The second interface 48 comprises sliding blocks 63 which may slide in a direction according to the double arrows. Hereby an oblique surface 64 of the sliding blocks 63 cooperate with an oblique surface 65 on a locking block 66 which are provided with toothing 67 corresponding to the toothing 62 on the rod 61. The locking blocks 66 may be displaced in order to bring the toothings in and out of engagement due to the action of the oblique surfaces as indicated by the double arrows 68. When a hydraulic pressure is released the active clamp may be disengaged.

1. Method for handling components during transferring of the components from a vessel situated on a sea surface and influenced by wave movements, to a fixed structure, wherein a crane comprising a bearing wire is provided at the fixed structure and which crane is arranged for effecting the transferring of the components, the method comprising the steps of:
A—providing a heave compensator being arranged with connection means for connection between the bearing wire and the component, wherein said heave compensator comprises at least one hydraulic piston-cylinder unit and at least one accumulator for compressed air, which accumulator is connected with the piston-cylinder unit,
B-I providing at least one active clamp being arranged with connection means for connection between the vessel and the component, wherein said active clamp is arranged for being controlled by a controller being able to release the clamp and thereby free the component from its connection to the vessel, or
B-II providing an accumulator which is arranged for being controlled by a controller in order to release compressed air from the accumulator into the piston-cylinder unit and thereby free the component from its position on the vessel by initiating a lift of the component,
C—providing means for monitoring wave movements,
D—arranging the vessel on site of the fixed structure,
E—connecting the heave compensator to the bearing wire
F—connecting the active clamps to the vessel and the component to be transferred, in the situation where step B-I is used, or connecting the accumulator to the piston-cylinder unit, in the situation where step B-II is used,
G—pre-setting the heave compensator for the load of the component to be transferred,
H—bringing the heave compensator in position for attachment to the component,
I—connecting the heave compensator to the component to be transferred and tightening the bearing wire to a pull where the heave compensator is operated in a middle area where a constant over-pull is established in the component to be transferred,
J—monitoring the wave movement and sending information of the wave movement to the controller,
K—calculating in the controller the wave movement to determine at least when crests are expected at the vessel,
L—releasing the active clamp, in the situation where step B-I is used, or releasing compressed air from the accumulator into the piston-cylinder unit, in the situation where step B-II is used, when the vessel is near a wave crest, which releasing is controlled by a control signal from the controller being submitted as a result of information from the monitoring of the wave movement,
M—hoisting the component from the vessel and transferring it to the fixed structure,
N—detaching the component from the heave compensator,
O—repeating the steps E to N until all necessary components are unloaded from the vessel,
P—removing the vessel from the site of the fixed structure, and
Q—arranging a new vessel on site of the fixed structure if more components are needed and repeating steps E to P.

2. Method according to claim 1, wherein Step A includes providing a heave compensator which is a passive heave compensator.

3. Method according to claim 2, wherein Step A includes providing a heave compensator comprising at least two hydraulic piston-cylinder units and at least two accumulators for compressed air.

4. Method according to claim 3, wherein Step A includes providing the at least two hydraulic piston-cylinder units with same or different lifting capacities.

5. Method according to claim 3, wherein Step A includes combining a selected number of the hydraulic piston-cylinder units by connecting these by opening/closing hydraulic valves arranged in pipe connections between the hydraulic piston-cylinder units and activating the selected number of hydraulic piston-cylinder units in order to obtain a desired lifting capacity for the load of the component to be transferred.

6. Method according to claim 1, wherein Step B includes remote controlling the active clamp with a signal from the control unit.

7. Method according to claim 1, wherein Step L includes a releasing the active clamp from the component leaving the active clamp still connected to the vessel.

8. Method according to claim 1, wherein Step I includes providing a lifting yoke customized to the specific component, arranging the component in the lifting yoke and connecting the heave compensator to the lifting yoke.

9. System for handling components during transferring of the components from a vessel situated on a sea surface and influenced by wave movements, to a fixed structure wherein a crane comprising a bearing wire is provided at the fixed structure and which crane is arranged for effecting the transferring of the components, wherein the system comprises:
A—a heave compensator being arranged with connection means for connection between the bearing wire and the component, wherein said heave compensator comprises at least one hydraulic piston-cylinder unit and at least one accumulator for compressed air,
B-I at least one active clamp being arranged with connection means for connection between the vessel and the component, wherein said active clamp is arranged for being controlled by a controller being able to release the clamp and thereby free the component from its connection to the vessel, or
B-II an accumulator which is arranged for being controlled by a controller in order to release compressed air from the accumulator into the piston-cylinder unit and thereby free the component from its position on the vessel by initiating a lift of the component, C—means for monitoring wave movements and
D—a control unit which is connected with the means for monitoring the wave movement, with the heave compensator and with the clamp and/or the accumulator.

10. System according to claim 9, wherein the heave compensator comprises at least two hydraulic piston-cylinder units and at least two accumulators for compressed air, wherein the at least two hydraulic cylinders have different lifting capacities and wherein the hydraulic cylinders are connected through pipe connections comprising hydraulic valves, which valves are arranged for being opened/closed thereby activating a selected number of hydraulic cylinders in order to obtain a desired lifting capacity for the load of the component to be transferred.
